(19) United States
(12) Patent Application Publication
(10) Pub. No.: US 2023/0108995 A1
(43) Pub. Date: Apr. 6, 2023

(54) MACHINE LEARNING PIPELINE FOR GEOREFERENCED IMAGERY AND POPULATION DATA

(71) Applicant: Fraym, Inc., Arlington, VA (US)

(72) Inventors: Swetha Ramaswamy, Arlington, VA (US); Robert Morello, Washington, DC (US); Christina Paton, New York, NY (US); Leith McIndewar, Washington, DC (US); Anna Vasylytsya, Alexandria, VA (US); Wei Kiet Tan, Washington, DC (US); Alexandra Filipovic, Northbrook, IL (US); Eddy Chebelyon, San Diego, CA (US); Jamie Sgro, Waterloo (CA); Benjamin Leo, Weems, VA (US)

(21) Appl. No.: 17/959,914

(22) Filed: Oct. 4, 2022

Related U.S. Application Data
(60) Provisional application No. 63/252,336, filed on Oct. 5, 2021.

(51) Int. Cl. G06V 10/80; G06V 20/10; G06V 10/774

(52) U.S. Cl. CPC G06V 10/803; G06V 10/774; G06V 20/10

(57) ABSTRACT

Methods and systems for improved analysis of population data and imagery data for a geographical area are provided. In one embodiment, a method is provided that includes receiving or extracting characteristics for a population and/or a geographical data. The characteristics may be combined with a variable of interest to form an input dataset. A first plurality of machine learning models may be trained based on at least a portion of the input dataset and may be used to generate a plurality of prediction surfaces for the variable of interest. A second plurality of machine learning models may be trained based on the plurality of prediction surfaces and at least one of the second plurality of machine learning models may be selected for future predictions of the variable of interest.

### CROSS-REFERENCE TO RELATED APPLICATIONS

This application claims priority under 35 U.S.C. § 119 to U.S. Provisional Pat. Application No. 63/252,336, filed on Oct. 5, 2021 in the United States Patent and Trademark Office, the entire contents of each hereby incorporated by reference.

### BACKGROUND

Data can often have geospatial characteristics. For example, aspects of a population such as population density, age, income, and the like may be geographically distributed. Accordingly, geographical information may be useful in predicting one or more aspects of a particular population in a particular geographic area.

### SUMMARY

The present disclosure presents new and innovative systems and methods for improved analysis of population data and imagery data for a geographical area. In a first aspect, a method is provided that includes receiving population data indicating characteristics of individuals living in a plurality of locations and determining corresponding georeferenced locations for a plurality of data entries within the population data. The method may also include storing the georeferenced locations in association with the plurality of data entries and identifying a variable of interest within at least a subset of the plurality of data entries. The method may further include training a machine learning model to predict the variable of interest using the population data.

In a second aspect according to the first aspect, training the machine learning model comprises extracting a plurality of characteristics from the subset of the plurality of data entries, combining the characteristics with the variable of interest to form an input dataset, and training a first plurality of machine learning models based on the input dataset. Training the machine learning model may also include generating, using the first plurality of machine learning models, a plurality of prediction surfaces for the variable of interest, training a second plurality of machine learning models based on the plurality of prediction surfaces, and selecting at least one first model of the second plurality of machine learning models for future predictions of the variable of interest.

In a third aspect according to any of the first and second aspects, the method further comprises generating, using the first model, a final prediction surface for the variable of interest.

In a fourth aspect according to any of the first through third aspects, the method further comprises cropping, the final prediction surface to account for at least one of (i) country borders and/or (ii) bodies of water and projecting the final prediction surface from a first coordinate system to a second coordinate system.

In a fifth aspect according to any of the first through fourth aspects, at least one of the first coordinate system and the second coordinate system is a World Geodetic System 1984 coordinate system.

In a sixth aspect according to any of the first through fifth aspects, the second coordinate system is selected based on a region containing the georeferenced locations.

In a seventh aspect according to any of the first through sixth aspects, the plurality of prediction surfaces includes a prediction surface generated by each of the first plurality of machine learning models.

In an eighth aspect according to any of the first through seventh aspects, the first plurality of machine learning models and the second plurality of machine learning models each include at least one of a generalized linear model, a support vector machine, a tree-based model, a neural network, and/or a spline model.

In a ninth aspect according to any of the first through eighth aspects, generating the plurality of prediction surfaces includes centering and scaling the input dataset.

In a tenth aspect according to any of the first through ninth aspects, receiving the population data comprises classifying the population into a plurality of predefined variables, deriving one or more additional characteristics from the population data, and recalculating weights for at least a subset of the characteristics based on demographic information for the individuals reflected in the population data.

In an eleventh aspect according to any of the first through tenth aspects, the weights are recalculated based on the demographic information using iterative proportional fitting.

In a twelfth aspect according to any of the first through eleventh aspects, the population data includes characteristics aggregated into clusters of multiple households and wherein the corresponding georeferenced locations are determined based on coordinates for the clusters.

In a thirteenth aspect according to any of the first through twelfth aspects, the georeferenced locations are projected onto a coordinate system.

In a fourteenth aspect according to any of the first through thirteenth aspects, the coordinate system is a regionally-based projection coordinate system.

In a fifteenth aspect according to any of the first through fourteenth aspects, storing the georeferenced locations includes assigning values for the characteristics to individual coordinate locations based on the values stored in the plurality of data entries.

In a sixteenth aspect, a system is provided that includes a processor and a memory. The memory may store instructions which, when executed by the processor, cause the processor to receive population data indicating characteristics of individuals living in a plurality of locations, determine corresponding georeferenced locations for a plurality of data entries within the population data, and store the georeferenced locations in association with the plurality of data entries. The instructions may also cause the processor to identify a variable of interest within at least a subset of the plurality of data entries and train a machine learning model to identify the variable of interest using the population data.

In a seventeenth aspect, a method is provided that includes receiving imagery data for a particular geographic location, wherein the imagery data includes data regarding one or more features and projecting the imagery data onto a coordinate system used by mapping data for the particular geographic location. The method may also include storing the one or more features from the imagery data in association with corresponding projected coordinates within the coordinate system and training a machine learning model to make predictions for a variable of interest based on the one or more features and corresponding projected coordinates.

In an eighteenth aspect according to the seventeenth aspect, training the machine learning model comprises combining the subset of the one or more features with the variable of interest to form an input dataset, training a first plurality of machine learning models based on the input dataset, and generating, using the first plurality of machine learning models, a plurality of prediction surfaces for the variable of interest. Training the machine learning model may further include training a second plurality of machine learning models based on the plurality of prediction surfaces and selecting at least one of the second plurality of machine learning models for future predictions of the variable of interest.

In a nineteenth aspect according to any of the seventeenth and eighteenth aspects, the method further comprises assessing the predictive power of each of the subset of the one or more features in predicting the variable of interest and removing at least one feature of the subset of the one or more features based on a predictive power associated with the at least one feature that is below a predetermined threshold.

In a twentieth aspect according to any of the seventeenth through nineteenth aspects, the method further comprises generating, using the at least one of the second plurality of machine learning models, a final prediction surface for the variable of interest.

In a twenty-first aspect according to any of the seventeenth through twentieth aspects, the coordinate system is a World Geodetic System 1984 coordinate system.

In a twenty-second aspect, a method is provided that includes extracting characteristics regarding a population and/or a geographic area, combining the characteristics with the variable of interest to form an input dataset, and training a first plurality of machine learning models based on at least a portion of the input dataset. The method may also include generating, using the first plurality of machine learning models, a plurality of prediction surfaces for the variable of interest, training a second plurality of machine learning models based on the plurality of prediction surfaces, and selecting at least one of the second plurality of machine learning models for future predictions of the variable of interest.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates a system for receiving and processing population and imagery data according to an exemplary embodiment of the present disclosure.

FIG. 2 illustrates a system for training models according to an exemplary embodiment of the present disclosure.

FIGS. 3A-3B illustrate prediction surfaces according to exemplary embodiments of the present disclosure.

FIG. 4 illustrates a method for receiving and processing population data according to an exemplary embodiment of the present disclosure.

FIG. 5 illustrates a method for receiving and processing imagery data according to an exemplary embodiment of the present disclosure.

FIG. 6 illustrates a method for model training and selection according to an exemplary embodiment of the present disclosure.

FIG. 7 illustrates a computer system according to an exemplary embodiment of the present disclosure.

### DETAILED DESCRIPTION OF EXAMPLE EMBODIMENTS

In order to make automated predictions on a geospatial basis, data is required that associates particular geographic locations with certain types of population characteristics. For example, received population data may often need to be converted from received information (e.g., survey data and the like) to be associated with particular, relevant locations. However, this conversion is not always straightforward. For example, received data may not always specify a corresponding location. As another example, different types of data (e.g., received from different sources) may specify the location in different ways. For example, certain types of received data may specify locations using one or more of postal codes, addresses, cities, states, provinces, latitudes and longitudes, and the like. Such data needs to be standardized in order to be used as the basis for predictions on an automated basis.

Additionally, determining geographical characteristics for a region (e.g., geological characteristics, hydrological characteristics, and the like) may be supplemented with imagery data for the region (e.g., maps of a particular region, satellite image data of a particular region, overhead imagery data captured by drones or other unmanned aerial vehicles). However, different imagery data may be available for different regions. For example, satellite imagery data may be generally available for multiple regions under analysis, but overhead imagery data may only be available in a subset of those regions and/or in a subset of a particular region. As another example, imagery data for different geographical regions may be plotted according to different coordinate systems, or maybe distorted in different ways (e.g., based on the different types of lenses used to capture associated images). In order to perform a comparative or predictive analysis across multiple regions (or across a region with different types of imagery data available), any corresponding imagery data needs to be standardized according to a common coordinate system and should include common features.

One solution to this problem is to automatically correct incoming population data and imagery data prior to analysis. For example, population data may be corrected by adjusting variable names and/or by projecting the locations contained within the population data onto a common coordinate system for use in future analyses. As another example, imagery data may be corrected by adjusting (e.g., renaming) or otherwise altering received feature information and projecting any provided location information onto the common coordinate system. In certain instances, image data may need to be corrected to account for the projection onto the common coordinate system and/or for other errors (e.g., lens distortions). The corrected population data and/or the corrected imagery data may then be used in subsequent analyses (e.g., comparative analyses, predictive analyses). For example, the corrected population data and the corrected imagery data may be used to perform a predictive analysis for a feature that is not included in either the corrected imagery data or the corrected population data.

However, even once the difficulties associated with received population data and/or imagery data have been addressed, automated analysis of the received data to generate predictions for particular types of population characteristics still require machine learning models to be trained and configured for predictions that are as accurate as possible. Given that the aggregated population and imagery data are non-standard, any such predictions may require specific training processes in order to generate the most accurate predictions for identified characteristics.

One solution to this problem is to use a multi-tiered machine learning model training process to prepare models that can make predictions based on imagery data and population data. In particular, a first plurality of models may be initially trained based on received (or previously stored) imagery data and/or population data. The first plurality of models may generate a plurality of prediction surfaces for a particular variable of interest (e.g., a variable of interest identified by a user or another computing process). A second plurality of models may then be trained based on the prediction surfaces generated by the first plurality of models. The second plurality of models may also generate a plurality of prediction surfaces, which may be used to select one of the second plurality of models for use in future predictions for the variable of interest. The selected model may then be used to generate a final prediction surface for the variable of interest.

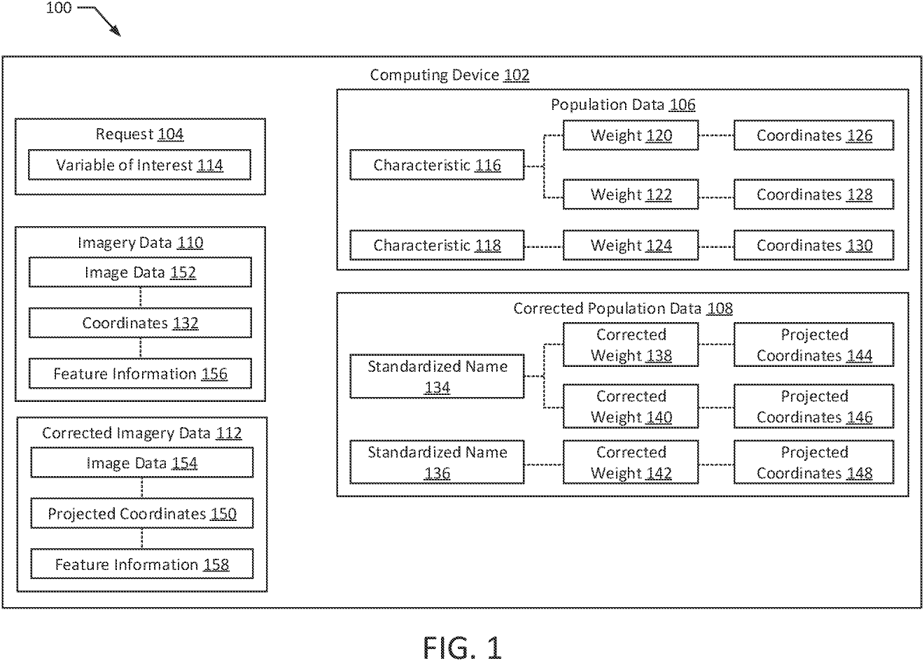

FIG. 1 illustrates a system 100 for receiving and processing population and imagery data according to an exemplary embodiment of the present disclosure. The system 100 includes a computing device 102. The computing device 102 may be configured to receive and process population data 106 and/or imagery data 110 for subsequent automated analysis and predictions (as discussed further below).

In particular, the computing device 102 may receive population data 106. For example, the computing device 102 may receive population data 106 from another computing device and/or a database. In one specific example, the computing device 102 may be communicatively coupled to a network (e.g., a wired or wireless network) and may receive the population data 106 from another computing device and/or from a database over the network. The population data 106 includes information regarding inhabitants (e.g., human inhabitants or non-human inhabitants) of one or more geographical areas. The population data 106 may include information received from the inhabitants themselves and/or may include information derived from other sources regarding the inhabitants. In certain implementations, the population data 106 may include information about specific, individual inhabitants. In additional or alternative implementations, the population data 106 may include aggregated information about multiple inhabitants living or working in a particular area within the geographical area (e.g., a particular household, a particular block, a particular postal code, a particular municipality, a particular employer, a particular square kilometer). For example, the population data 106 may include one or more of survey data received from one or more inhabitants of the geographical area, aggregated census data regarding the population any particular area, data extracted from satellite or overhead imagery (e.g., size of dwellings, number of dwellings, type of roofing, type of landscaping, presence of paved roads, size of roadways, number of vehicles).

The population data 106 includes particular characteristics 116, 118. The characteristics 116, 118 may be specific to particular identifying fact or feature about an individual inhabitant or a population in a particular location. For example, the characteristics 116, 118 may specify one or more of an education level, income, gender, age, number of children, marital status, ethnicity, and the like for one or more individuals located within a particular location. In certain instances, the characteristics 116, 118 may regard a particular individual (e.g., a gender for a particular individual) located at a particular location. In additional or alternative instances, the characteristics 116, 118 may be aggregated for multiple individuals (e.g., a percentage or number of male, female, non-binary inhabitants of a particular region or location). The values for the characteristics 116, 118 may be specified as weights 120, 122, 124. The weights 120, 122, 124 may specify a value for the characteristics 116, 118 and particular locations, indicated by the coordinates 126, 128, 130. In certain implementations, the weights 120, 122, 124 may specify a particular, specific value for the characteristics 116, 118. For example, the weight 120 may specify that an individual living at the coordinates 126 had an annual income of $12,532 in 2019. In additional or alternative implementations, the weights 120, 122, 124 may specify a range, bucket, or classification for characteristics 116, 118. For example, the weight 122 may specify that an individual living at the coordinates 128 had an annual income of $10,000-$15,000 in 2019.

As indicated above, locations associated with the weights 120, 122, 124 may be identified by corresponding coordinates 126, 128, 130. The coordinates 126, 128, 130 may specify the corresponding locations using one or more location parameters. For example, the coordinates 126, 128, 130 may specify one or more of a postal code, an address, a city, a municipality, a business, a city block, latitude and longitude coordinates, the center of a corresponding square kilometer, and the like. In certain implementations, the coordinates 126, 128, 130 may include different location parameters for the corresponding locations. For example, the weight 120 may correspond to an individual household in the coordinates 126 may specify a particular address for the household. As another example, the weight 122 may correspond to a town, and the coordinates 128 may specify the corresponding town. As a further example, the weight 124 may indicate the characteristic 118 for a particular county, and the coordinates 130 may identify the corresponding county.

In order to consistently incorporate the population data 106 and the subsequent analyses and predictions, the weights 120, 122, 124 and coordinates 126, 128, 130 may need to be corrected and/or standardized. For example, subsequent analysis (e.g., by one or more machine learning models) may rely on characteristic data aggregated to a county level. Accordingly, it may be necessary to generate corrected population data 108 that standardizes the received population data 106 to the characteristics necessary for future analysis.

To generate corrected population data 108, the computing device 102 may determine one or more projected coordinates 144, 146, 148 based on the coordinates 126, 128, 130. For example, the projected coordinates 144 may correspond to the coordinates 126, the projected coordinates 146 may correspond to the coordinates 128, and the predicted coordinates 148 may correspond to the coordinates 130. The projected coordinates 144, 146, 148 may be determined by converting the locations identified by the coordinates 126, 128, 130 (e.g., at a particular level of granularity, using a particular geographical coordinate system) to a single, common level of granularity and/or to a single, common geographical coordinate system. In certain implementations, the common geographical coordinate system may be a regionally-based coordinate system, such as the World Geodetic System 1984 (WGS84) coordinate system. As one specific example, the coordinates 126, 128, 130 may be specified using the Universal Transverse Mercator (UTM) coordinate system and the projected coordinates 144, 146, 148 may be generated by converting the coordinates 126, 128, 130 to the WGS84 coordinate system. As another example, the coordinates 126, 128, 130 may identify particular clusters of households for the corresponding weights 120, 122, 124, and the projected coordinates 144, 146, 148 may be identified by determining corresponding latitude and longitude coordinates for the identified clusters of households (e.g., in the WGS84 coordinate system). In certain instances, the coordinate system for the projected coordinates 144, 146, 148 may be selected based on a region for the population data 106 (e.g., the coordinates 126, 128, 130). For example, the WGS84 coordinate system may be selected for use in locations in Asia. As another example, the LAEA coordinate system may be selected for use in other locations (e.g., Africa).

To generate corrected population data 108, the computing device 102 may also determine one or more standardized names 134, 136. The standardized names 134, 136 may identify a particular, predetermined type of characteristic used in subsequent analysis of the population data 106. For example, the standardized names 134, 136 may include a median household income for the region, and average number of occupants per household for a particular ZIP Code, and the like. In certain instances, generating the standardized names 134, 136 may include changing a variable name or field name for the characteristics 116, 118 contained within the population data 106. For example, where the population data 106 contains the characteristics 116, 118 in a tabular database, the standardized names 134, 136 may be generated by changing variable names for the characteristics 116, 118 (e.g., changing the titles of a corresponding column within the database, changing the name of corresponding fields).

Generating the corrected population data 108 may further include an initial analysis or manipulation of the weights 120, 122, 124 (e.g., adjusting or aggregating the weights 120, 122, 124). For example, the computing device 102 may calculate the household income in a region based on multiple income data entries for households within the region and may generate a corrected weight 138, 140, 142 that reflects the average household income within the region. In certain implementations, the corrected weights 138, 140, 142 may be calculated to correct statistical imbalances in the population sample used to generate the population data 106. For example, the computing device 102 may calculate the corrected weights 138, 140, 142 to correct for imbalances in income, housing status, race, gender, age, level of education, and the like. The computing device 102 may use iterative proportional fitting to calculate the corrected weights 138, 140, 142, although one skilled in the art will recognize that additional or alternative statistical rebalancing techniques may be used. In certain implementations, the corrected population data 108 may include a different number of corrected weights 138, 140, 142 than weights 120, 122, 124 in the population data 106. In certain implementations, the corrected weights 138, 140, 142 may also exclude certain types of characteristics. In still further implementations, corrected weights 138, 140, 142 may include generating new characteristics or variables based on the received population data 106. For example, a plurality of survey responses for a particular individual may be aggregated into a single corrected weight 138, 140, 142. As one specific example, a survey may include responses about specific dates on which an individual received polio vaccine doses, and these responses may be analyzed and aggregated into a single Boolean weight indicating whether the individual has been completely immunized against polio. As another example, received data may include information on a roofing material for a structure in a particular location, and the roofing material may be compared to a list of “completed” roofing materials for a corresponding region to generate a new Boolean weight indicating whether the structure has a completed roof according to the materials available in the region.

The computing device 102 may also be configured to receive and process imagery data 110. Imagery data 110 may depict images captured of a particular geographical region. In particular, the imagery data 110 may include image data 152 that may depict images captured using different types of imaging techniques (e.g., overhead images captured using satellites, overhead images captured using UAVs, mapping data generated for the region, three-dimensional overhead scans of the region). In certain implementations, the imagery data 110 may include corresponding coordinates 132 for the image data 152 (e.g., for individual pixels and/or regions). Similar to the coordinates 126, 128, 130, the coordinates 132 may be specified at a particular level of granularity (e.g., latitude or longitude coordinates, a city where the region is located, a city block for the corresponding pixels, a county for the corresponding pixels, a square kilometer for the corresponding pixels). Additionally or alternatively, the coordinates 132 may be in a particular coordinate system (e.g., the UMS coordinate system, the Lambert azimuthal equal-area (LAEA) coordinate system). The imagery data 110 also includes feature information 156, which may include terrain information for regions depicted within particular pixels or portions of the image data 152. For example, the feature information 156 may identify one or more of elevation, presence, and type of bodies of water, types of soil, presence of buildings, presence and type of roadways, zoning classifications, and the like.

The computing device 102 may be configured to generate corrected imagery data 112 based on the received imagery data 110. In particular, the corrected imagery data 112 may be generated to comply with data standardization requirements for future analysis (e.g., data types or formats required by a machine learning model). For example, the computing device 102 may generate projected coordinates 150 for the corrected imagery data 112. Generating the projected coordinates 150 may include converting the coordinates 132 into a different coordinate system that is required for subsequent analyses. For example, the imagery data 110 may contain coordinates 132 within the UMS coordinate system, and the projected coordinates 150 may be generated by converting the coordinates 132 from the UMS coordinate system to the WGS84 coordinate system. In certain implementations, generating the corrected imagery data 112 may also include changing the granularity for projected coordinates 150 and/or image data 154 within the imagery data 110. For example, the projected coordinates 150 may occur at a different density than the coordinates 132. As another example, the image data 154 may be adjusted so that each pixel of the image data 154 covers a different area (e.g., a larger area, a smaller area) than each pixel within the image data 152. In certain implementations, the image data 154 may also be adjusted from the image data 152 (e.g., by applying a mask or other transformation to the visual components of the image data 152). For example, the image data 154 may be generated by applying one or more transformations the image data 152 to correct for, e.g., lens distortions, differences in coloration, and the like. In still further implementations, the image data 152 may include multiple images, and generating the image data 154 may include combining the multiple images into a single image. The images may be combined based on associated coordinates 132 and/or common geometrical or geographical features within the images.

The corrected imagery data 112 may also include feature information 158 adjusted from the feature information 156 in the imagery data 110. For example, the feature information 158 may include standardized feature names, similar to the standardized names 134, 136. In certain implementations, the feature information 158 may also exclude unsupported features from the feature information 156. Additionally or alternatively, the feature information 158 may be generated by converting numeric values in the feature information 156 to integer values (e.g., to reduce storage space required) and/or updating empty or “n/a” values in the feature information 156 to a predetermined value (e.g., “NULL”, “0”, an interpolated value based on adjacent values). In certain implementations, the feature information 158 may include summary statistics for the features from the feature information 156 (e.g., maximum value, minimum value, mean value, median value, and/or standard deviation). Furthermore, the feature information 158 may be generated to include one or more spatial features for subsequent use by a machine learning model. For example, the spatial features may combine certain features from the feature information 156 at various, related locations, and such feature may be used by the machine learning model in future processing. As one specific example, the spatial features may include one or more of distances from a point of interest (e.g., a predefined type of location such as homes, roads, stores, and the like).

The computing device 102 may also be configured to receive a request 104 to perform an analysis based on the corrected population data 108 and/or the corrected imagery data 112. The request 104 may identify a variable of interest 114. In particular, the request 104 may identify the variable of interest 114 for which a predicted geographic distribution is to be generated (e.g., by the computing device 102 and/or another computing device). The request 104 may be received from a user (e.g., via a graphical user interface) and/or from an automated process (e.g., a process that determines whether a prediction is needed for a particular type of data, such as future housing development, future income distribution). In response to receiving the request 104, the computing device 102 may identify a corresponding characteristic (e.g., one of the characteristics 116, 118 and/or or one of the standardized names 134, 136) for subsequent analysis. The corresponding characteristic may be identified based on a variable name for the variable of interest 114. For example, the computing device 102 may perform one or more keyword searches on the variable of interest 114. In one specific example, the variable of interest 114 may identify “income” as the requested variable and may identify “median household income” as the corresponding characteristic. In certain instances, the variable of interest 114 may also identify the corresponding characteristic. For example, the user may create a request via a graphical user interface, which may include a drop-down menu of available characteristics (e.g., standardized names of available characteristics). As another example, the variable of interest 114 may include data for a geographic region or a particular period of time. The request 104 may identify that prediction is desired for the same variable within another region and/or for another period of time. For example, the computing device 102 may contain corrected population data 108‘s regarding houses with improved roofs in the last five years in a particular geographical area and the request 104 may be prepared via a graphical user interface to identify, as the variable of interest 114, houses with improved roofs in the last five years in a nearby geographical region. As explained further below, the computing device 102 and/or another computing device may then perform the requested analysis (e.g., using one or more machine learning models).

Although not depicted, the computing device 102 may contain a memory and/or a processor configured to implement one or more operational features of the computing device 102. For example, the memory may contain instructions which, when executed by the processor, may cause the processor to implement one or more of the above-discussed operational features of the computing device 102. Furthermore, in the above-discussed embodiments, the computing device 102 is discussed as a single computing device. However, in various other implementations, the computing device 102 may be implemented by multiple computing devices. The computing device 102 may communicate with other computing devices (e.g., to receive the request 104, population data 106, and/or imagery data 110) using a network. For example, the computing device 102 may communicate with the network using one or more wired network interfaces (e.g., Ethernet interfaces) and/or wireless network interfaces (e.g., Wi-Fi ®, Bluetooth ®, and/or cellular data interfaces). In certain instances, the network may be implemented as a local network (e.g., a local area network), a virtual private network, L1 and/or a global network (e.g., the Internet).

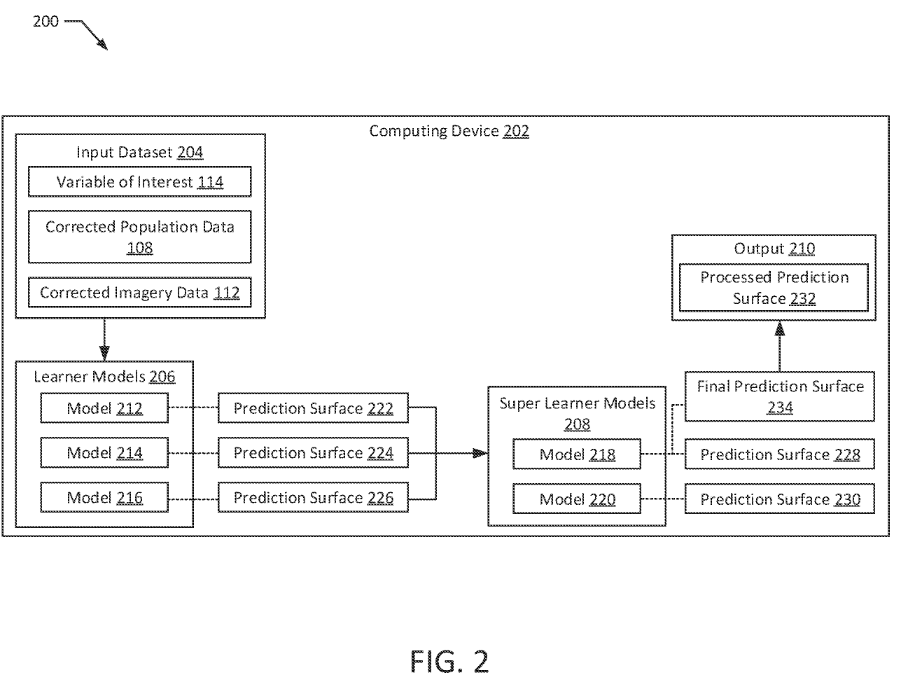

FIG. 2 illustrates a system 200 for training models according to an exemplary embodiment of the present disclosure. The system 200 includes a computing device 202 configured to receive an input dataset 204 and to perform a requested analysis for identified variables of interest 114 based on the input dataset 204. In certain implementations, the computing device 202 may be the same computing device as the computing device 102. In additional or alternative implementations, the computing devices 102, 202 may be implemented separately (e.g., as two or more computing devices). In further implementations, the computing device 202 may receive the request 104 instead of the computing device 102.

The input dataset 204 contains the variable of interest 114, corrected population data 108, and corrected imagery data 112. The input datasets 204 may be generated by the computing device 102 and/or by the computing device 202. For example, the computing device 102 may generate the input dataset 204 based on the received request 104 and the generated corrected population data 108 and corrected imagery data 112. In additional or alternative implementations, the computing device 202 may receive the request 104, corrected population data 108, and corrected imagery data 112 separately, which may be combined to form the input dataset 204. In certain implementations, only a subset of the corrected population data 108 and/or the corrected imagery data 112 may be included within the input dataset 204. The subset of included data may be selected by a user and/or may be selected based on the results of previous prediction operations. For example, where the variable of interest 114 is future construction activity in a geographical activity, the input dataset 204 may be generated to exclude particular features from the corrected population data 108 that have previously been determined to have low predictive power for construction activity (e.g., number of household doctor visits).

To perform the requested analysis, the computing device 202 may be configured to train or update learner models 206 and/or super learner models 208 based on the input dataset 204. For example, in certain implementations, the input dataset 204 may be divided for use in training and/or validating the learner models 206 and/or the super learner models 208. For example, portions of the corrected population data 108 and the corrected imagery data 112 may be divided into multiple, smaller datasets (e.g., a first dataset used for training models 206, 208 and a second dataset used for validating the models 206, 208). The learner models 206 may be configured to generate initial prediction surfaces 222, 224, 226. In particular, the learner models 206 may include a plurality of standardized (e.g., predetermined) models 212, 214, 216 that generate predicted surfaces for the variable of interest 114. In certain implementations, the learner models 206 may be configured to require each of the models 212, 214, 216 to use all of the data contained within a training dataset (e.g., a subset of the corrected population data 108 and/or a subset of the corrected imagery data 112). The learner models 206 may be so required to prevent feature engineering from being performed to selectively exclude variables within the input datasets 204 at this stage. In certain implementations, the models 212, 214, 216 may include one or more of a generalized linear model, a support vector machine, a tree-based model, a neural network, and/or a spline model. In certain implementations, the learner models 206 may be trained according to a predetermined training regimen. For example, training the learner models 206 may include a K-fold training requirement (e.g., a 10-fold training requirement). In addition to the prediction surfaces 222, 224, 226, the computing device 202 may also store a ranking or other indication of variable importance for the variables within the corrected population data 108 and/or the corrected imagery data 112. In particular, the ranking may include an ordered list of the characteristics and/or features within the corrected population data 108 and the corrected imagery data 112 (e.g., for most predictive to least predictive, or vice versa). In certain implementations, the learner models 206 may also be trained to center and/or scale the input datasets 204.

The super learner models 208 may contain individual models 218, 220 that are configured to generate prediction surfaces 228, 230 based on the prediction surfaces generated by other models. In particular, the super learner models 208 may be trained based on the prediction surfaces 222, 224, 226 generated by the learner models 206, instead of data from the input dataset 204. For example, the super learner models 208 may receive the prediction surfaces 222, 224, 226,or data derived from the prediction surfaces 222, 224, 226 as the input and all or part of a training dataset (e.g., the same portion of the training dataset as the learner models 206, a different portion of the training dataset as the learner models 206). In certain implementations, the super learner models 208 may be trained using similar techniques (e.g., similar types of models, a similar training regimen) as the learner models 206. For example, the super learner models 208 may include one or more of a generalized linear model, a support vector machine, a tree-based model, a neural network, and/or a spline model and may be trained according to a K-fold training requirement. The super learner models 208 may also each be configured to generate prediction surfaces 228, 230 for the variable of interest 114.

The computing device 202 may then analyze the prediction surfaces 228, 230 to identify a most accurate model 218, 220 from among the super learner models 208. For example, the computing device 202 may compute and compare a root mean squared error for the prediction surfaces 228, 230 in comparison to a validation dataset selected from the input dataset 204. The computing device 202 may then select one of the models 218, 220 to generate a final prediction surface 234 for the variable of interest 114. For example, the corrected population data 108 and/or the corrected imagery data 112 may include data regarding a first geographical area, which the prediction surfaces 222, 224, 226, 228, 230 may be generated to represent. To generate the final prediction surface 234, the selected model (e.g., model 218) may be provided with population data and/or imagery data for a second, new geographical area (e.g., identified within a request 104). The model 218 may then generate a final prediction surface 234 for the new geographical area based on the newly-received data.

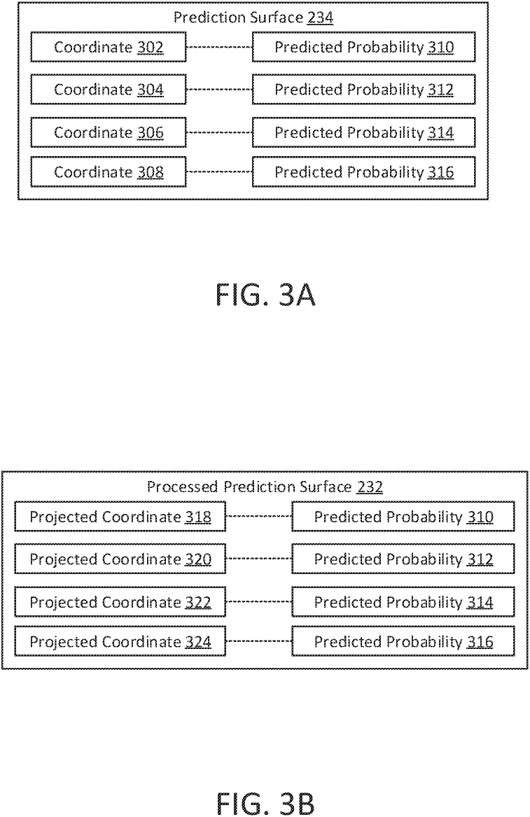

An implementation of the prediction surface 234 is depicted in FIG. 3A. The prediction surface 234 stores coordinates 302, 304, 306, 308 and associated predicted probabilities 310, 312, 314, 316. The coordinates may be in a first coordinate system (e.g., LAEA, WGS84). In certain implementations, the predicted probabilities 310, 312, 314, 316 may indicate a likelihood for a variable of interest to occur (e.g., a floating or other numerical indicator of a predicted likelihood from 0-1, from 0%-100%). In additional or alternative implementations, the predicted probabilities 310, 312, 314, 316 may indicate a predicted value (or weight) for the variable of interest. For example, the predicted probabilities 310, 312, 314, 316 may include a predicted percentage of a population in the geographical area that meets a specified criteria, a predicted median income at one or more locations, a predicted number of residents per household, a predicted number of children per household, and the like.

In certain implementations, the prediction surface 234 may be stored as an image (e.g., with a color gradient used to visually represent predicted probabilities 310, 312, 314, 316 at the various coordinates 302, 304, 306, 308 within a depicted geographical area. In additional or alternative implementations, the prediction surface 234 may be stored as a table or other type of a database containing the coordinates 302, 304, 306, 308 that are associated predicted probabilities 310, 312, 314, 316. Although not specifically depicted, prediction surfaces 222, 224, 226, 228, 230 may be implemented using techniques similar to those discussed above in connection with the prediction surface 234 in FIG. 3A.

Furthermore, in certain implementations, multiple prediction surfaces 234 may be generated for the variable of interest 114. For example, the computing device 202 may generate two separate prediction surfaces 234 that represent a prediction interval for the variable of interest. In one specific example, the model 218 and/or the computing device 202 may determine a standard deviation for the prediction surface 234 (e.g., for multiple locations within the prediction surface 234). The computing device 202 may then use the standard deviation to generate an upper-bound prediction surface (e.g., representing a 95% confidence) and a lower-bound prediction surface (e.g., representing a 5% confidence level). Together, the upper-bound and lower-bound prediction surfaces may represent a prediction interval for the variable of interest 114. In certain instances, the computing device 202 may further calculate a global tau penalty statistic (e.g., based on the mean prediction and mean-squared error for the variable of interest 114 within the prediction surface 234) and may apply the tau penalty statistic to the upper-bound and lower-bound confidence intervals to more accurately represent the prediction interval.

Returning to FIG. 2, the computing device 202 may then process the prediction surface 234 into a processed prediction surface 232, which is included in an output 210 of the computing device 202. In certain implementations, generating the processed prediction surface may include converting the coordinates 302, 304, 306, 308 to a different coordinate system (e.g., a coordinate system better suited to properly displaying the geographic area). For example, and turning to FIG. 3B, the processed prediction surface 232 may contain the projected coordinates 318, 320, 322, 324. The projected coordinates 318, 320, 322, 324 may be converted from coordinates 302, 304, 306, 308 in a first geographic coordinate system (e.g., LAEA) into a second coordinate system (e.g., WGS84). In certain implementations, the predicted probabilities 310, 312, 314, 316 may not be changed when generating the processed prediction surface 232. In additional or alternative implementations, however, the predicted probabilities in the processed prediction surface 232 may include adjusted or otherwise altered versions of the predicted probabilities 310, 312, 314, 316 within the prediction surface 234. For example, the predicted probabilities 310, 312, 314, 316 may be aggregated into a lower level of granularity (e.g., according to privacy requirements). As one specific example, predicted data on an individual household level may be aggregated into city-level data, square kilometer-level data, and/or block-level data.

In certain implementations, generating the processed prediction surface 232 may further include adjusting the prediction surface 234 to account for various geographical features. For example, generating the processed prediction surface 232 may include one or more of excluding certain geographic features (e.g., bodies of water, mountains, national parks) from the prediction surface 234, cropping the prediction surface 234 based on nearby borders for a desired city, state, country, or region (e.g., based on a shape file for desired borders), interpolating any missing values within the prediction surface 234 (e.g., missing predicted probabilities 310, 312, 314, 316 for certain locations within the depicted region), normalizing the predicted probabilities 310, 312, 314, 316 (e.g., between 0 and 1), and the like. Furthermore, in certain implementations, the prediction surfaces 222, 224, 226, 228, 230 and/or the processed prediction surface 232 may be stored as data (e.g., numerical data) in a tabular format or other database storage format. In additional or alternative implementations, the prediction surfaces 222, 224, 226, 228, 230 and/or the processed prediction surface 232 may be stored as images (e.g., in TIF format, JPEG format, pain format, vector format, and the like).

Although not depicted, the computing device 202 may contain a memory and/or a processor configured to implement one or more operational features of the computing device 102. For example, the memory may contain instructions which, when executed by the processor, may cause the processor to implement one or more of the above-discussed operational features of the computing device 202. Furthermore, in the above-discussed embodiments, the computing device 202 is discussed as a single computing device. However, in various other implementations, the computing device 202 may be implemented by multiple computing devices. The computing device 202 may communicate with other computing devices (e.g., to receive the input dataset 204) using a network. For example, the computing device 202 may communicate with the network using one or more wired network interfaces (e.g., Ethernet interfaces) and/or wireless network interfaces (e.g., Wi-Fi ®, Bluetooth ®, and/or cellular data interfaces). In certain instances, the network may be implemented as a local network (e.g., a local area network), a virtual private network, L1 and/or a global network (e.g., the Internet).

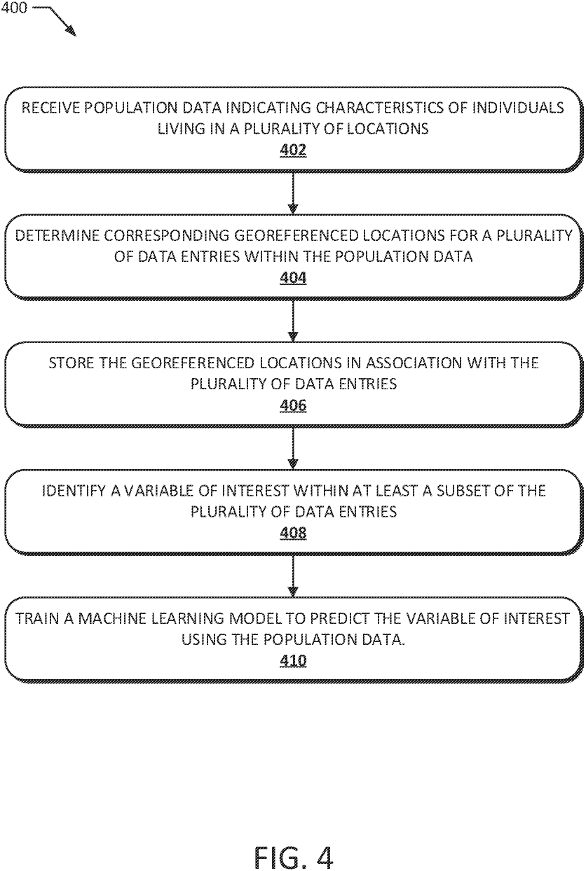

FIG. 4 illustrates a method 400 for receiving and processing population data according to an exemplary embodiment of the present disclosure. The method 400 may be implemented on a computer system, such as the systems 100, 200. For example, the method 400 may be implemented by the computing device 102, 202. The method 400 may also be implemented by a set of instructions stored on a computer readable medium that, when executed by a processor, cause the computer system to perform the method 400. For example, all or part of the method 400 may be implemented by a processor and a memory of the computing device 102 and/or the computing device 202. Although the examples below are described with reference to the flowchart illustrated in FIG. 4, many other methods of performing the acts associated with FIG. 4 may be used. For example, the order of some of the blocks may be changed, certain blocks may be combined with other blocks, one or more of the blocks may be repeated, and some of the blocks described may be optional.

The method 400 may begin with receiving population data indicating characteristics of individuals living in a plurality of locations (block 402). For example, a computing device 102 may receive population data 106 indicating characteristics 116, 118 of individuals living in a plurality of locations. The plurality of locations may be represented as coordinates 126, 128, 130. In certain implementations, the characteristics 116, 118 may include information regarding specific individuals living within a geographic area (e.g., at specific coordinates). In additional or alternative implementations, the characteristics 116, 118 may include population data regarding an aggregate population living within a geographic area (e.g., within specific coordinates, in a plurality of households centered at particular coordinates).

Corresponding georeferenced locations may be determined for a plurality of data entries within the population data (block 404). For example, the computing device 102 may determine georeferenced locations in the form of projected coordinates 144, 146, 148 for a plurality of data entries within the population data 106. In particular, individual data entries may be represented as weights 120, 122, 124 corresponding to one or more characteristics 116, 118 represented by the population data 106. Determining the corresponding georeferenced locations may include identifying corresponding coordinates 126, 128, 130 and generating projected coordinates 144, 146, 148 based on the coordinates 126, 128, 130. In certain implementations, the population data 106 may not include coordinates 126, 128, 130. In such implementations, the projected coordinates 144, 146, 148 may need to be determined based on other information contained within the population data 106 or another data source. For example, each of the weights 120, 122, 124 may include an identifier of a corresponding city, and the projected coordinates 144, 146, 148 may be determined for the corresponding city. In additional or alternative implementations, weights 120, 122, 124 may be associated with particular individuals and/or particular businesses, and determining the georeferenced locations may include identifying projected coordinates 144, 146, 148 based on an address associated with the particular individual and/or particular business.

The georeferenced locations may be stored in association with the plurality of data entries (block 406). For example, the computing device 102 may store the projected coordinates 144, 146, 148 and corrected population data 108 in association with the plurality of data entries. In certain implementations, the corrected population data 108 may include corrected weights 138, 140, 142, which may be generated as described above to correct one or more discrepancies with the weights 120, 122, 124 within the originally-received population data 106. In additional or alternative implementations, the corrected population data 108 may instead be generated to include the original weights 120, 122, 124. In further implementations, the corrected population data 108 may be generated to aggregate weights according to one or more predetermined variables (e.g., to generate a Boolean variable based on multiple survey data responses).

A variable of interest may be identified within at least a subset of the plurality of data entries (block 408). For example, the computing device 102 may identify a variable of interest 114 within at least a subset of the plurality of data entries within the corrected population data 108 and/or the originally-received population data 106. An indicator of the variable of interest 114 may be received from another computing device via a request 104. Identifying the variable of interest 114 may include identifying a corresponding characteristic (e.g., one or more corresponding characteristics 116, 118 and/or standardized names 134, 136) within the population data 106 and/or the corrected population data 108. As explained above, the corresponding characteristic may be identified based an indication received with the variable of interest 114 (e.g., within the request 104). In additional or alternative implementations, corresponding characteristic may be selected using one or more heuristics (e.g., keyword searching based on a name for the variable of interest or a data type for the variable of interest) and/or based on the results of previous prediction operations (e.g., characteristics or standardized names with high predictive value in the previous prediction operations with the variable of interest similar to the identified variable of interest 114.

A machine learning model may then be trained to predict the variable of interest using the population data (block 410). For example, the population data 106 and/or the corrected population data 108 may be used to training a machine learning model, such as one or more learner models 206 and/or super learner models 208. In certain implementations, and as discussed in greater detail below in connection with the method 600, training the machine learning model may include generating one or more prediction surfaces based on the corrected population data 108 and/or imagery data received by the computing device 102. In certain implementations training the machine learning model may include dividing the population data 106 and/or the corrected population data 108 into a plurality of datasets, which may be used for training and/or validation purposes.

In this way, the computing device 102 is able to automatically and accurately process and prepare population data received from various sources. In particular, by determining corresponding georeferenced locations (e.g., determining corresponding locations, standardizing the coordinates for received locations), the computing device 102 may be able to standardize received population data 106 for use in a subsequent prediction operations using machine learning models that rely on population data in a particular format (e.g., to have particular variable names, to have particular statistical distributions, to have particular geographical coordinate systems). Furthermore, as discussed in greater detail above in connection with FIG. 1, processing the received population data 106 may further include one or more of determining standardized names for the characteristics within the population data 106 and/or determining corrected weights for the weights within the population data 106. In such implementations, the corrected population data 108 may be further able to comply with standardized variable names and/or standardized statistical distributions required by machine learning models trained in block 410.

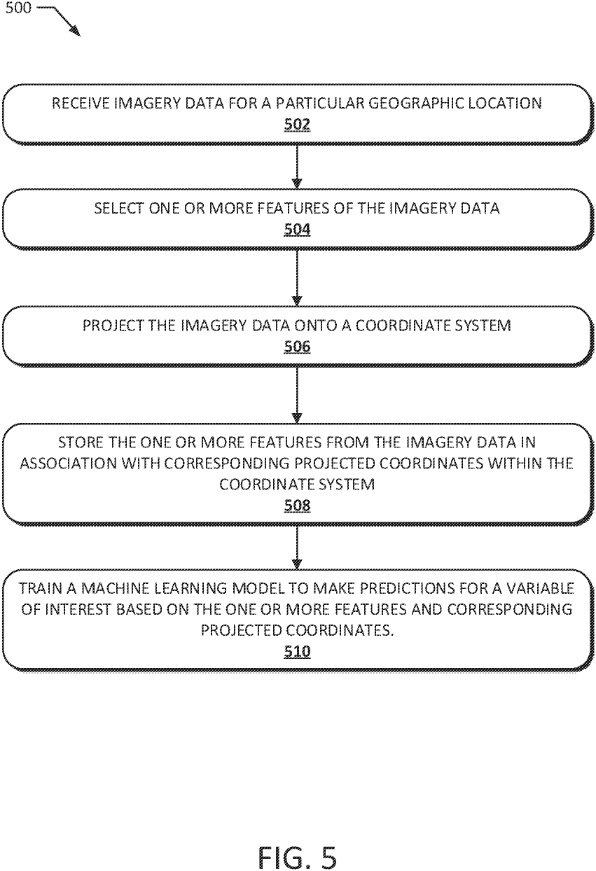

FIG. 5 illustrates a method 500 for receiving and processing imagery data according to an exemplary embodiment of the present disclosure. The method 500 may be implemented on a computer system, such as the systems 100, 200. For example, the method 500 may be implemented by the computing device 102, 202. The method 500 may also be implemented by a set of instructions stored on a computer readable medium that, when executed by a processor, cause the computer system to perform the method 500. For example, all or part of the method 500 may be implemented by a processor and a memory of the computing device 102 and/or the computing device 202. Although the examples below are described with reference to the flowchart illustrated in FIG. 5, many other methods of performing the acts associated with FIG. 5 may be used. For example, the order of some of the blocks may be changed, certain blocks may be combined with other blocks, one or more of the blocks may be repeated, and some of the blocks described may be optional.

The method 500 may begin with receiving imagery data for a particular geographic location (block 502). For example, a computing device 102 may receive imagery data 110 for a particular geographic region. The imagery data 110 may include image data 152, which may represent overhead imagery of the particular geographic area. As explained above, the overhead imagery may be captured using one or more modalities (e.g., UAVs, satellite imagery, 3D scans or models of the geographic area). Furthermore, the image data 152 may be associated with one or more coordinates 132, which may represent geographic locations depicted in corresponding pixels of the image data 152. For example, in certain implementations, individual pixels within the image data 152 may each have corresponding coordinates 132. In additional or alternative implementations, each coordinate 132 may be associated with more than one pixel within the image data 152. Furthermore, the imagery data 110 may contain feature information 156 associated with one or more of the coordinates 132. As explained further above, the feature information 156 may represent one or more geographical, zoning, or other characteristics of the corresponding geographic location.

One or more features of the imagery data may be selected (block 504). For example, the computing device 102 may select one or more features from the feature information 156 of the imagery data 110. In certain implementations, the computing device 102 may only select a subset of the features contained within the feature information 156. For example, the machine learning models trained to analyze imagery data 110 and/or corrected imagery data 112 may only be compatible with a certain subset of features (e.g., certain types of geographical features, certain zoning restrictions). Accordingly, the computing device 102 may only select a subset of the features from the feature information 156 to include within the feature information 158 of the corrected imagery data 112. In additional or alternative implementations, the computing device 102 may include all of the features contained within the feature information 156 within the feature information 158 of the corrected imagery data 112.

The imagery data may be projected onto a coordinate system (block 506). For example, the computing device 102 may project the imagery data 110 onto a coordinate system for subsequent analysis. For example, the coordinate system may be selected as a coordinate system compatible with machine learning models used for subsequent predictive analysis of the corrected imagery data 112. In one specific example, subsequent machine learning models may rely on the WGS84 coordinate system, and the computing device 102 may generate projected coordinates 150 for the corrected imagery data 112 by converting the coordinates 132 within the imagery data 110 into the WGS84 coordinate system. In certain instances, the image data 152 may also have to be adjusted or otherwise transformed to account for the desired coordinate system. For example, the computing device 102 may convert the image data 152 in a first coordinate system into image data 154 in the desired coordinate system (e.g., WGS84) by applying one or more predefined transformations to the image data 152 (e.g., associated with the first and desired coordinate systems).

One or more features from the imagery data 110 may be stored in association with the corresponding projected coordinates within the coordinate system (block 508). For example, the computing device 102 may store the one or more features selected at block 504 in association with corresponding projected coordinates 150. In particular, the computing device 102 may generate corrected imagery data 112 containing the projected coordinates 150, corrected imagery data 154, and feature information 158 containing the one or more features selected at block 504.

A machine learning model may be trained to make predictions for a variable of interest based on the one or more features and the corresponding projected coordinates (block 510). For example, the corrected imagery data 112 may be used to train one or more machine learning models (e.g., learner models 206, super learner models 208) to make predictions for a variable of interest 114. For example, the variable of interest 114 may be identified in a request 104 received by the computing device 102. In certain implementations, and as discussed in greater detail below in connection with the method 600, training the machine learning model may include generating one or more prediction surfaces for the variable of interest 114 based on the corrected imagery data 112. In certain implementations training the machine learning model may include dividing the corrected imagery data 112 into a plurality of datasets, which may be separately used for training and/or validation purposes.

In this way, the computing device 102 is able to automatically process and prepare imagery data 110 received from various sources and/or various imaging modalities. In particular, by adjusting the coordinates 132 and/or image data 152 into a particular coordinate system utilized in subsequent analysis, the computing device 102 is able to ensure compatibility of imagery data received from various sources. Furthermore, by pruning the feature data 156 to only include compatible features, the computing device 102 is able to preemptively avoid compatibility issues created by new sources of imagery data 110. By increasing the available data sources and types for use by subsequent machine learning models, the method 500 is able to improve the accuracy of predictions generated by the models.

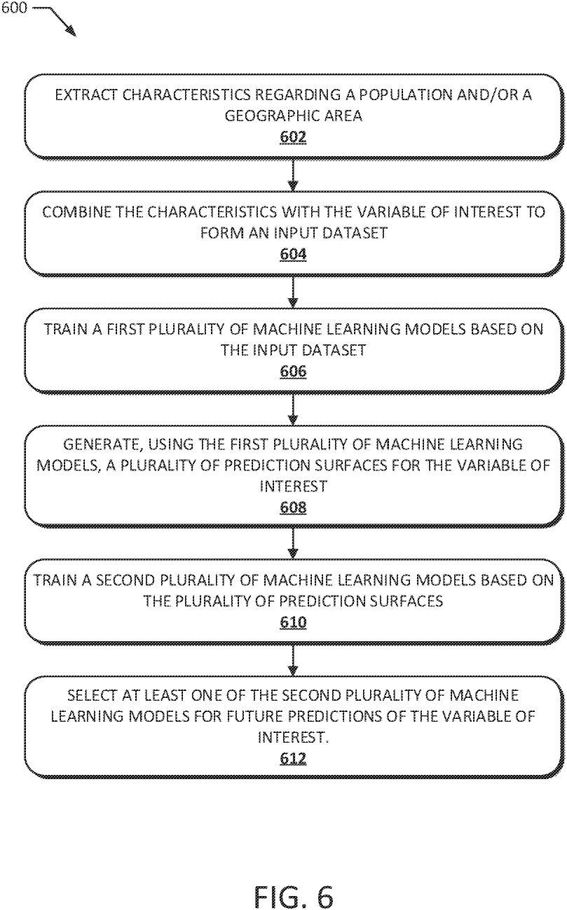

FIG. 6 illustrates a method 600 for model training and selection according to an exemplary embodiment of the present disclosure. The method 600 may be implemented on a computer system, such as the systems 100, 200. For example, the method 600 may be implemented by the computing device 102, 202. The method 600 may also be implemented by a set of instructions stored on a computer readable medium that, when executed by a processor, cause the computer system to perform the method 600. For example, all or part of the method 600 may be implemented by a processor and a memory of the computing device 102 and/or the computing device 202. Although the examples below are described with reference to the flowchart illustrated in FIG. 6, many other methods of performing the acts associated with FIG. 6 may be used. For example, the order of some of the blocks may be changed, certain blocks may be combined with other blocks, one or more of the blocks may be repeated, and some of the blocks described may be optional.

The method 600 may begin with extracting characteristics regarding a population and/or a geographic area (block 602). For example, the computing device 202 may extract characteristics regarding a population and/or a geographic area by receiving and processing population data 106 and/or imagery data 110 to form corrected population data 108 and/or corrected imagery data 112. Extracting characteristics regarding a population may include receiving population data 106 and generating corrected population data 108 according to the method 400. Extracting characteristics regarding a geographic area may include receiving imagery data 110 and generating corrected imagery data 112 according to the method 500.

The characteristics may be combined with a variable of interest to form an input dataset (block 604). For example, a computing device 102, 202 may generate an input dataset 204 containing a variable of interest 114, corrected population data 108, and/or corrected imagery data 112. As explained above, the variable of interest 114 may be received within a request 104. In certain implementations, the input dataset 204 may be received by a computing device 202 from another computing device 102 and/or may be generated by the computing device 202 (e.g., where the computing device 202 is the same as the computing device 102).

A first plurality of machine learning models may be trained based on the input dataset (block 606). For example, a computing device 202 may training a first plurality of machine learning models 212, 214, 216 based on the input dataset 204. In particular, the first plurality of machine learning models may include learner models 206, which may be trained on at least a subset of the input dataset 204. In particular, the input dataset may be divided into two or more subsets: a first subset used for training the learner models 206 and a second subset used for validating one or both of the learner models 206 and the super learner models 208. As explained further above, training the learner models 206 may include a K-fold training regimen.

A plurality of prediction surfaces for the variable of interest may be generated using the first plurality of machine learning models (block 608). For example, the computing device 202 may use the first plurality of machine learning models 212, 214, 216 to generate a plurality of prediction surfaces 222, 224, 226 for the variable of interest 114. In particular, after training the first plurality of machine learning models 212, 214, 216 has been completed, the computing device 202 may use a final output prediction surface 222, 224, 226 and each of the first plurality of machine learning models 212, 214, 216 for subsequent processing. As explained further above, prediction surfaces may contain coordinates and associated predicted probabilities for the variable of interest 114.

A second plurality of machine learning models may be trained based on the plurality of prediction surfaces (block 610). For example, the computing device 202 may train a second plurality of machine learning models 218, 220 based on the prediction surfaces 222, 224, 226. In particular, the second plurality of machine learning models 218, 220 may include super learner models 208 configured to be trained based on prediction surfaces 222, 224, 226 for particular variables of interest. In particular, as explained above, the super learner models 208 to may receive the prediction surfaces 222, 224, 226 as input data in lieu of population data and/or imagery data. As explained further above, training the super learner models 208 may include a K-fold training regimen, similar to the learner models 206.

At least one of the second plurality of machine learning models may be selected for future predictions of the variable of interest (block 612). For example, the computing device 202 may select at least one of model 218 of the second plurality of machine learning models 218, 220 for future predictions of the variable of interest 114. In particular, the computing device 202 may compute an error measurement for prediction surfaces 228, 230 generated by each of the second plurality of machine learning models 218, 220 (e.g., relative to an evaluation data subset of the input dataset 204). The computing device 202 may then select the model 218 with the lowest error measurement for future predictions of the variable of interest 114. In certain implementations, selecting the model 218 may include processing a prediction surface 228 generated by the model 218 to generate a processed prediction surface 232 as the output 210 for the prediction operation requested by the request 104, as discussed in further detail above. In still further implementations, a predictive power of one or more variables (e.g., characteristics of the population data, features of the imagery data) within one or more of the second plurality of models 218, 220 may be assessed. For example, the computing device 202 may include a further machine learning model trained to assess the predictive power of variables (e.g., through sensitivity analysis) and may generate a ranking of the predictive power of variables. This ranking may be used in future prediction operations (e.g., to select characteristics from the population data and/or features from the imagery data) for subsequent analysis. Additionally or alternatively, variables may be removed from the input dataset 204 (e.g., when a predictive power for the variables is below a predetermined threshold).

In this way, the computing device 202 is able to utilize a unique training architecture that relies on two tiers of models: learner models 206 trained based on the input dataset 204 and super learner models 208 trained on the output from the learner models 206. This technique for training models to generate prediction surfaces may improve the accuracy of subsequent predictions. Furthermore, by integrating the corrected population data 108 and the corrected imagery data 112 within the input datasets 204, the computing device 202 is able to rely on additional sources of training data for the machine learning models 212, 214, 216, 218, 220. Accordingly, prediction surfaces 228 and process prediction surfaces 232 generated in output by the computing device 202 may have increased accuracy relative to machine learning techniques that do not utilize learner models and/or super learner models in are not able to integrate disparate sources of imagery and population data.

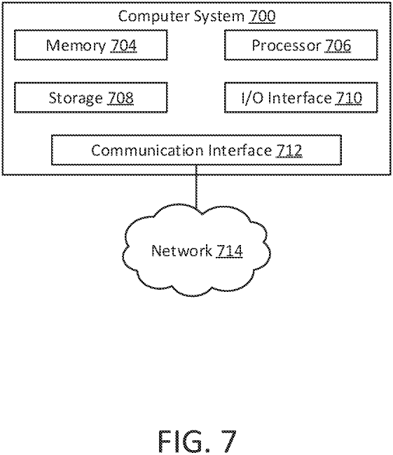

FIG. 7 illustrates an example computer system 700 that may be utilized to implement one or more of the devices and/or components discussed herein, such as the systems 100, 200. In particular embodiments, one or more computer systems 700 perform one or more steps of one or more methods described or illustrated herein, such as the methods 400, 500, 600. In particular embodiments, one or more computer systems 700 provide the functionalities described or illustrated herein. In particular embodiments, software running on one or more computer systems 700 performs one or more steps of one or more methods described or illustrated herein or provides the functionalities described or illustrated herein. Particular embodiments include one or more portions of one or more computer systems 700. Herein, a reference to a computer system may encompass a computing device, and vice versa, where appropriate. Moreover, a reference to a computer system may encompass one or more computer systems, where appropriate.

This disclosure contemplates any suitable number of computer systems 700. This disclosure contemplates the computer system 700 taking any suitable physical form. As example and not by way of limitation, the computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 706, memory 704, storage 708, an input/output (I/O) interface 710, and a communication interface 712. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 706 includes hardware for executing instructions, such as those making up a computer program. As an example and not by way of limitation, to execute instructions, the processor 706 may retrieve (or fetch) the instructions from an internal register, an internal cache, memory 704, or storage 708; decode and execute the instructions; and then write one or more results to an internal register, internal cache, memory 704, or storage 708. In particular embodiments, the processor 706 may include one or more internal caches for data, instructions, or addresses. This disclosure contemplates the processor 706 including any suitable number of any suitable internal caches, where appropriate. As an example and not by way of limitation, the processor 706 may include one or more instruction caches, one or more data caches, and one or more translation lookaside buffers (TLBs). Instructions in the instruction caches may be copies of instructions in memory 704 or storage 708, and the instruction caches may speed up retrieval of those instructions by the processor 706. Data in the data caches may be copies of data in memory 704 or storage 708 that are to be operated on by computer instructions; the results of previous instructions executed by the processor 706 that are accessible to subsequent instructions or for writing to memory 704 or storage 708; or any other suitable data. The data caches may speed up read or write operations by the processor 706. The TLBs may speed up virtual-address translation for the processor 706. In particular embodiments, processor 706 may include one or more internal registers for data, instructions, or addresses. This disclosure contemplates the processor 706 including any suitable number of any suitable internal registers, where appropriate. Where appropriate, the processor 706 may include one or more arithmetic logic units (ALUs), be a multi-core processor, or include one or more processors 706. Although this disclosure describes and illustrates a particular processor, this disclosure contemplates any suitable processor.

In particular embodiments, the memory 704 includes main memory for storing instructions for the processor 706 to execute or data for processor 706 to operate on. As an example, and not by way of limitation, computer system 700 may load instructions from storage 708 or another source (such as another computer system 700) to the memory 704. The processor 706 may then load the instructions from the memory 704 to an internal register or internal cache. To execute the instructions, the processor 706 may retrieve the instructions from the internal register or internal cache and decode them. During or after execution of the instructions, the processor 706 may write one or more results (which may be intermediate or final results) to the internal register or internal cache. The processor 706 may then write one or more of those results to the memory 704. In particular embodiments, the processor 706 executes only instructions in one or more internal registers or internal caches or in memory 704 (as opposed to storage 708 or elsewhere) and operates only on data in one or more internal registers or internal caches or in memory 704 (as opposed to storage 708 or elsewhere). One or more memory buses (which may each include an address bus and a data bus) may couple the processor 706 to the memory 704. The bus may include one or more memory buses, as described in further detail below. In particular embodiments, one or more memory management units (MMUs) reside between the processor 706 and memory 704 and facilitate accesses to the memory 704 requested by the processor 706. In particular embodiments, the memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory implementations, this disclosure contemplates any suitable memory implementation.

In particular embodiments, the storage 708 includes mass storage for data or instructions. As an example and not by way of limitation, the storage 708 may include a hard disk drive (HDD), a floppy disk drive, flash memory, an optical disc, a magneto-optical disc, magnetic tape, or a Universal Serial Bus (USB) drive or a combination of two or more of these. The storage 708 may include removable or non-removable (or fixed) media, where appropriate. The storage 708 may be internal or external to computer system 700, where appropriate. In particular embodiments, the storage 708 is non-volatile, solid-state memory. In particular embodiments, the storage 708 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 708 taking any suitable physical form. The storage 708 may include one or more storage control units facilitating communication between processor 706 and storage 708, where appropriate. Where appropriate, the storage 708 may include one or more storages 708. Although this disclosure describes and illustrates particular storage, this disclosure contemplates any suitable storage.

In particular embodiments, the I/O Interface 710 includes hardware, software, or both, providing one or more interfaces for communication between computer system 700 and one or more I/O devices. The computer system 700 may include one or more of these I/O devices, where appropriate. One or more of these I/O devices may enable communication between a person (i.e., a user) and computer system 700. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 710 may include one or more device or software drivers enabling processor 706 to drive one or more of these I/O devices. The I/O interface 710 may include one or more I/O interfaces 710, where appropriate. Although this disclosure describes and illustrates a particular I/O interface, this disclosure contemplates any suitable I/O interface or combination of I/O interfaces.

In particular embodiments, communication interface 712 includes hardware, software, or both providing one or more interfaces for communication (such as, for example, packet-based communication) between computer system 700 and one or more other computer systems 700 or one or more networks 714. As an example and not by way of limitation, communication interface 712 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 714 and any suitable communication interface 712 for the network 714. As an example and not by way of limitation, the network 714 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 700 may include any suitable communication interface 712 for any of these networks, where appropriate. Communication interface 712 may include one or more communication interfaces 712, where appropriate. Although this disclosure describes and illustrates a particular communication interface implementations, this disclosure contemplates any suitable communication interface implementation.

The computer system 702 may also include a bus. The bus may include hardware, software, or both and may communicatively couple the components of the computer system 700 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-PIN-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
receiving population data indicating characteristics of individuals living in a plurality of locations;
determining corresponding georeferenced locations for a plurality of data entries within the population data;
storing the georeferenced locations in association with the plurality of data entries;
identifying a variable of interest within at least a subset of the plurality of data entries; and
training a machine learning model to predict the variable of interest using the population data.

2. The method of claim 1, wherein training the machine learning model comprises:
extracting a plurality of characteristics from the subset of the plurality of data entries;
combining the characteristics with the variable of interest to form an input dataset;
training a first plurality of machine learning models based on the input dataset;
generating, using the first plurality of machine learning models, a plurality of prediction surfaces for the variable of interest;
training a second plurality of machine learning models based on the plurality of prediction surfaces; and
selecting at least one first model of the second plurality of machine learning models for future predictions of the variable of interest.

3. The method of claim 2, wherein the method further comprises generating, using the first model, a final prediction surface for the variable of interest.

4. The method of claim 3, wherein the method further comprises:
cropping, the final prediction surface to account for at least one of (i) country borders and/or (ii) bodies of water; and
projecting the final prediction surface from a first coordinate system to a second coordinate system.

5. The method of claim 4, wherein at least one of the first coordinate system and the second coordinate system is a World Geodetic System 1984 coordinate system.

6. The method of claim 4, wherein the second coordinate system is selected based on a region containing the georeferenced locations.

7. The method of claim 2, wherein the plurality of prediction surfaces includes a prediction surface generated by each of the first plurality of machine learning models.

8. The method of claim 2, wherein the first plurality of machine learning models and the second plurality of machine learning models each include at least one of a generalized linear model, a support vector machine, a tree-based model, a neural network, and/or a spline model.

9. The method of claim 2, wherein generating the plurality of prediction surfaces includes centering and scaling the input dataset.

10. The method of claim 1, wherein receiving the population data comprises:
classifying the population into a plurality of predefined variables ;
deriving one or more additional characteristics from the population data; and
recalculating weights for at least a subset of the characteristics based on demographic information for the individuals reflected in the population data.

11. The method of claim 10, wherein the weights are recalculated based on the demographic information using iterative proportional fitting.

12. The method of claim 1, wherein the population data includes characteristics aggregated into clusters of multiple households and wherein the corresponding georeferenced locations are determined based on coordinates for the clusters.

13. The method of claim 1, wherein the georeferenced locations are projected onto a coordinate system.

14. The method of claim 13, wherein the coordinate system is a regionally-based projection coordinate system.

15. The method of claim 1, wherein storing the georeferenced locations includes assigning values for the characteristics to individual coordinate locations based on the values stored in the plurality of data entries.

16. A system comprising:
a processor; and
a memory storing instructions which, when executed by the processor, cause the processor to:
receive population data indicating characteristics of individuals living in a plurality of locations;
determine corresponding georeferenced locations for a plurality of data entries within the population data;
store the georeferenced locations in association with the plurality of data entries;
identify a variable of interest within at least a subset of the plurality of data entries; and
train a machine learning model to identify the variable of interest using the population data.

17. A method comprising:
receiving imagery data for a particular geographic location, wherein the imagery data includes data regarding one or more features;
projecting the imagery data onto a coordinate system used by mapping data for the particular geographic location;
storing the one or more features from the imagery data in association with corresponding projected coordinates within the coordinate system; and
training a machine learning model to make predictions for a variable of interest based on the one or more features and corresponding projected coordinates.

18. The method of claim 17, wherein training the machine learning model comprises:
combining the subset of the one or more features with the variable of interest to form an input dataset;
training a first plurality of machine learning models based on the input dataset
generating, using the first plurality of machine learning models, a plurality of prediction surfaces for the variable of interest;
training a second plurality of machine learning models based on the plurality of prediction surfaces; and
selecting at least one of the second plurality of machine learning models for future predictions of the variable of interest.

19. The method of claim 18, wherein the method further comprises:
assessing the predictive power of each of the subset of the one or more features in predicting the variable of interest; and
removing at least one feature of the subset of the one or more features based on a predictive power associated with the at least one feature that is below a predetermined threshold.

20. The method of claim 18, wherein the method further comprises generating, using the at least one of the second plurality of machine learning models, a final prediction surface for the variable of interest.

21. The method of claim 17, wherein the coordinate system is a World Geodetic System 1984 coordinate system.

22. A method comprising:
extracting characteristics regarding a population and/or a geographic area;
combining the characteristics with the variable of interest to form an input dataset;
training a first plurality of machine learning models based on at least a portion of the input dataset;
generating, using the first plurality of machine learning models, a plurality of prediction surfaces for the variable of interest;
training a second plurality of machine learning models based on the plurality of prediction surfaces; and
selecting at least one of the second plurality of machine learning models for future predictions of the variable of interest.
